(19) United States
(12) Patent Application Publication
(10) Pub. No.: US 2002/0013429 A1
(43) Pub. Date: Jan. 31, 2002

(54) Process and equipment for the preparation of an olefinic polymer

(76) Inventors: Leo Smit, Oirsbeek (NL); Frits P. Moens, Geleen (NL); Stanislaus M. P. Mutsers, Geleen (NL)

Correspondence Address: PILLSBURY WINTHROP LLP, 1600 TYSONS BOULEVARD, MCLEAN, VA, 22102, US

(21) Appl. No.: 09/833,076

(22) Filed: Apr. 12, 2001

Related U.S. Application Data
(63) Continuation of application No. PCT/NL99/00627, filed on Oct. 11, 1999.

(30) Foreign Application Priority Data
Oct. 12, 1998 (NL) 1010294

(51) Int. Cl. C08F 2/00; C08F 2/01

(52) U.S. Cl. 526/65; 526/68; 526/69; 526/70; 526/348.2; 526/348.3; 526/348.4; 526/348.5; 526/348.6; 526/351; 526/352; 526/335; 422/131; 422/135

(57) ABSTRACT

The invention relates to a process and a device that are suitable for the preparation of a polymer based on an olefinic monomer and optionally one or more comonomers that are copolymerisable therewith, in a horizontal reactor, divided into at least two zones and fitted with a stirring mechanism, which is operated under subfluidization conditions, the polymer formed being discharged from the reactor separately from other reactor effluent, it being possible to vary the composition of the overall feed to be supplied to a zone between two zones at least and the reactor effluent separated from polymer leaving the reactor as a single stream, at least part of this stream being returned to the reactor as feed after one or more separating steps.

The invention relates to a process for the preparation of a polymer based on an olefinic monomer and optionally one or more comonomers that are copolymerisable therewith in a horizontal reactor, divided into at least two zones and fitted with a stirring mechanism, which is operated under subfluidisation conditions, the polymer formed being discharged from the reactor separately from other reactor effluent.

The process described above is known from U.S. Pat. No. 3,957,448.

A drawback of the known process is that the reactor effluent (other than the polymer formed) leaves the two-zone reactor in two streams, which streams each have their own separating and purifying device. This leads to non-flexible, or less flexible production situations and results in high equipment costs for carrying out such a process, which make the process economically less attractive. This would be even more the case if the reactor were to contain three or more zones.

The aim of the invention is to entirely or partly eliminate the drawback.

This is achieved by using a process in which the composition of the overall feed to be supplied to a zone can be varied between two zones, the reactor effluent separated from polymer leaving the reactor as one stream and at least part of this stream being returned to the reactor as a feed stream via one or more separating steps.

An advantage is that, with a process according to the invention, it is possible to feed a different composition (in terms of components and quantity) to the reactor per zone in an economically attractive way. It is even possible, if several inlets are employed per zone, to have the composition vary per inlet. And all this even in spite of the only singular discharge of the reactor effluent.

Another advantage or such a process is that it is easy and economically profitable to control the polymer's properties by supplying feeds of different compositions to different inlets in the reactor. Together with the possibility of controlling the polymer properties by varying the temperature and pressure, the possibility of preparing a tremendous variety of polymers thus arises.

Another advantage is that with this process it is extremely easy, in operating the polymerisation process, to allow for a changing activity of the catalyst, for example because the catalyst's activity decreases in the course of time (“decay-type catalyst”) or on the contrary because the catalyst becomes more active after an inhibition period.

It has surprisingly now been found that it is possible to prepare polymers with a broad or bimodal, or even a multimodal molecular weight distribution (molar mass distribution, MWD) , with the process according to the invention.

Yet another advantage of the process according to the invention is that it is possible to prepare block copolymers in a single reactor.

The process according to the invention can be used in any reactor that has been divided into at least two zones. The presence of those two zones makes it possible to prepare polymers that can be regarded as a mixture of two types of polymers, that is, if the reaction conditions in the two zones differ. The result of this is that the polymer that leaves the reactor has a broad or bimodal molecular weight distribution. Whether it will be bimodal or broad will depend on the degree by which the average molar mass of the polymer from one zone differs from the average molar mass from the other zone. Only above a certain difference will the molar mass distribution of the ultimate polymer be recognisable as having two maxima. If the degree of differences is less, a large part of the two molar mass curves will coincide, so that the overall curve will be (very) broad, but will not be split into two maxima. The molar masses and molar mass distributions are determined via gel-permeation chromatography (GPC), as well-known to a person skilled in the field of polymers.

If the reactor comprises more than two zones, there will be the possibility of supplying feeds with different compositions to two zones. Preferably, however, the reactor that consists of more than two zones is operated so that the composition of the overall feed to be supplied to one zone differs from a previous zone. This is advantageous because in such a way optimum use is made of the reactor's possibilities and the broadest possible product, whether or not bi- or multimodal, can be prepared. An additional advantage is that in this way allowance can best be made for changing catalyst behaviour per zone.

The polymers that can be prepared with the process according to the invention are based on an olefinic monomer and optionally one or more comonomers that are copolymerisable therewith. The term ‘monomer’ is here and hereinafter understood to mean a polymerisable compound that is present in the polymer formed to a predominant degree. ‘Comonomer’ is understood to be a compound polymerisable with the monomer that is present in a smaller amount than the monomer. Several types of comonomers may be present in the polymer formed. In that case the total concentration of comonomers may be higher than the monomer concentration, but the concentration of each comonomer separately is lower than the monomer concentration. The degree to which a monomer or comonomer is present is determined on a molar basis.

The olefinic monomer that is present to a predominant degree may be for example a terminally unsaturated hydrocarbon. The terminally unsaturated hydrocarbon may be branched or unbranched and may contain 2-12 carbon atoms. Preferably use is made of ethylene or propylene.

The comonomer that is copolymerisable with the olefinic monomer may be a different olefinic monomer, but conjugated and non-conjugated dienes are also suitable. Preferably the comonomer is chosen from the group consisting of terminally unsaturated hydrocarbons having 2-12 carbon atoms and conjugated and non-conjugated dienes having 4-20 carbon atoms If use is made of a terminally unsaturated hydrocarbon, ethylene, propylene, 1-butylene, 1-hexene, 4-methyl-1-pentene or 1-octene are preferable. Butadiene, 1,4-hexadiene, ethylidenenorbornene or dicyclopentadiene is preferably used as a diene.

The polymer that is formed during the reaction in the reactor is discharged from the reactor separately from other reactor effluent. Here and hereinafter the term ‘reactor effluent’ is understood to be the stream of compounds, minus the polymer formed, that leaves the reactor. The polymer can be separated from the reactor effluent in different ways, which are known to a person skilled in the art. With every method for separating the polymer from the reactor effluent, the risk of a certain amount of monomer, comonomer and/or cooling agent contained in the polymer being discharged will be unavoidable. The reason for this is that these compounds ‘dissolve’ in the polymer as it were. These compounds must later be removed from the polymer. A person skilled in the art knows how this can be done.

The polymerisation is usually effected in the presence of a catalyst system. The term ‘catalyst system’ is here understood to mean that it is possible to polymerise in the presence of, as a person skilled in the art will call it, only one catalyst or in the presence of a combination of a catalyst and a suitable cocatalyst

What type of catalyst is chosen will depend on the polymer that is to be prepared. A person skilled in the art will know what type of catalyst can be used for what type of polymer.

It is well possible to supply different catalysts to the different zones in de reactor. By using this possibility alone, in addition to other possibilities of control, the properties of the polymer ultimately obtained can be optimally controlled. This will for example make it possible to prepare a bi- or multimodal product. Preferably a transition-metal catalyst is supplied to the reactor in at least two places. This process is preferably used to make use of a metallocene catalyst in addition to a Ziegler-Natta or Phillips catalyst.

More preferably a prepolymerised catalyst is supplied to the reactor in the process according to the invention. An advantage of using a prepolymerised catalyst is that the occurrence of so-called hot-spots is largely prevented. ‘Hot-spots’ are Understood to imply the occurrence of a (very) local, undesired rise in temperature. This phenomenon can adversely affect the quality of the polymer and it also has an adverse effect on the accuracy with which the reactor can be operated. Another advantage is that the morphology of the catalyst, and hence also of the polymer ultimately obtained, can be better controlled by using a prepolymerised catalyst.

Usually the growth of the polymer chains is controlled during the polymerisation. This control can be effected with the aid of the temperature and pressure in the reactor and by changing the concentration of the catalyst used and by adding substances with a chain-regulating effect. Such chain regulators are known to a person skilled in the art. An example is hydrogen.

In the process according to the invention it is possible to supply different concentrations of chain regulator very specifically to different zones. This presents the advantage of very accurate control of the desired polymer properties.

A substantial amount of reaction heat is released in the polymerisation. This reaction heat must in one way or another be discharged from the reactor because otherwise it will no longer be possible to control the reaction and either undesired products will be formed or, in a more serious case, the reaction will become uncontrollable.

To achieve an efficient discharge of heat from a reactor used in the process according to the invention, a fluid cooling agent that evaporates under the conditions in the reactor is usually supplied to the reactor. By evaporating, the fluid cooling agent withdraws heat from the reactor's contents. The cooling agent that has evaporated is discharged from the reactor together with the rest of the reactor effluent.

Suitable cooling agents are substances with a high heat of evaporation. Suitable cooling agents are alkanes, for example propane, butane, pentane or mixtures thereof. If ethylene is polymerised, propane or isobutane is preferably used as the cooling agent. If the monomer (or comonomer) that is polymerised can be easily condensed, for example propylene, then the fluid (co)monomer or a mixture of the fluid (co)monomer and an additional cooling agent can be used as the cooling agent.

Preferably the cooling agent is supplied at a flow rate such that the polymer bed in the reactor remains ‘dry’. This is intended to mean that the partial pressure of the cooling agent is kept below the dew point. But preferably the rate at which the cooling agent is supplied is chosen to be as high as possible, so that the greatest possible cooling effect is achieved. A person skilled in the art will through simple experimentation be able to determine what will under the desired reaction conditions be the optimum rate for the addition of the cooling agent.

The cooling agent can be supplied to the bed from the bottom, but then the polymer bed will become ‘wet’ at the point at which the fluid cooling agent is supplied. The cooling agent is therefore preferably supplied via the reactor's gas hood, to make the best use of the cooling capacity. An additional advantage of supply via the gas hood is that the concentration of compounds present in the polymer, such as monomer, comonomer and cooling agent, will be lower, which will simplify the purification of the polymer.

The point at which the different compounds, such as monomer, comonomer, chain regulator and optionally other compounds, are to be supplied will depend predominantly on the relative vapour pressure of the compound concerned. The lower a compound's vapour pressure, the more preferably the compound is to be supplied via the reactor's gas hood. Preferably the monomer and the chain regulator are supplied to the solid phase in the reactor and the comonomer and any auxiliaries to be used via the reactor's gas hood.

The catalyst and the cocatalyst optionally to be used are preferably supplied via the reactor's gas hood, because then a better distribution can be achieved, as a result of which the risk of e.g. hot-spots will be lower.

The invention also relates to a device suitable for carrying out a process according to the invention for the preparation of a polymer based on an olephinic monomer and optionally one or more comonomers that are copolymerisable therewith comprising a horizontal reactor divided into at least two zones and fitted with a stirring mechanism.

The device described above is known from U.S. Pat. No. 3,957,448.

A drawback of the described device, as is also evident from FIG. 4 in U.S. Pat. No. 3,957,448, is that it comprises a lot of equipment. This will be even more the case if there are more than two zones, because then even more purification sections will be required. This will imply high investment and maintenance costs. This is undesirable from an economic viewpoint.

An additional drawback of a device comprising many equipment items is that defects or breakdowns may occur in many places. So such a device requires a relatively large amount of control to be able to operate reliably.

The aim of the invention is to entirely or partly eliminate the aforementioned drawbacks.

This aim is achieved by offering a device which, in addition to the reactor, also comprises a separating device comprising one or more equipment items for separating the reactor effluent into the components, and means for returning these components to the reactor. Often use is made of a piece of equipment with a condenser function, after which the fluid obtained from the condenser is in a further purification section separated into the components. A portion at least of the components thus separated is then returned to the reactor as feed. A ‘condenser’ is here understood to be a piece of equipment that causes a vapour stream to cool and condense and that separates the gas obtained and the fluid obtained, notably in a situation of thermodynamic equilibrium. The apparatus that separates the fluid obtained from the condenser into the components operates in a situation in which there is no thermodynamic equilibrium.

An advantage of such a device according to the invention is that this device makes it possible to meter a feed to each zone of the reactor, while varying the composition of the overall feed to be supplied to a zone between two zones at least. This increases the device's flexibility. Using a device according to the invention also makes it possible to prepare polymers whose properties can be very accurately controlled. This means that mono-, bi- or multimodal products can be prepared as desired.

The apparatus with a condenser function serves to liquefy the condensable part of the reactor effluent.

The apparatus that separates the fluid obtained from the condenser into its components serves to separate the compounds present, including monomer, comonomer and cooling agent, to a great extent, so that streams are formed that can be returned to the reactor. Before the streams are returned to the reactor, a fresh feed can be supplied to thus compensate for the consumption and any losses.

The apparatus that separates the fluid obtained from the condenser into its components is preferably a distillation device.

The degree of separation in the apparatus that separates the fluid obtained into its components can be easily set by a person skilled in the art by controlling the temperature and pressure depending on the composition of the supplied stream. This is well known to a person skilled in the art. The degree of separation is hence not predetermined, but can be set. Preferably the degree of separation that is effected in the apparatus is between 60 and 100%. This degree is then expressed in the purity of the separated components. More preferably the degree of separation is between 75 and 100%. Even more preferably it is between 90 and 100%. The higher the degree of separation, and hence the higher the purity of the separated components, the easier it will be to control the conditions in the reactor. In tho most desirable case of almost 100% separation, block polymers, for example, can be prepared because, if so desired, a 100% monomer A or 100% monomer B environment can be maintained alternately in each zone. The situation of almost 100% separation is however difficult to realise in practice, except at (extremely) high costs. Therefore it must be each time decided whether the costs involved in such a substantial separation are economically justifiable. Another example that can be realized with an almost 100% separation is the situation in which a chain regulator, for example hydrogen, is not supplied to one zone and is supplied to another zone. Such control makes it possible to prepare also polymers with a broad to very broad molar mass distribution.

The chain regulator H₂ can be separated from the other components in the reactor effluent or in the gas stream from the condenser in several ways. Examples are a second condenser, a scrubber, or it is possible to use membrane technology or metal hydride technology. Other methods are known to a person skilled in the art.

The reactor in the process and the device according to the invention is a horizontal reactor, divided into at least two zones and fitted with a stirring mechanism. The division into two or more zones can be realised by placing vertical or substantially vertical baffles, distributed at regular distances over the length of the reactor during the construction of the reactor. The baffles may be designed in many different ways; the way in which they are designed is not a critical factor. A person skilled in the art will easily be able to determine a suitable shape.

Preferably the aim of the baffles, which is to create a number of zones, possibly with different reaction conditions, in terms of both (gas) composition and reaction conditions, is realised without using physical baffles. The zoned division is then obtained by choosing a type of stirrer that ensures transport of the solid phase, but also ensures that as little mixing of solid substance as possible takes place in the direction of the reactor's longitudinal axis. In such a case it is hence not necessary to insert some form of baffles to nevertheless maintain zones. This is advantageous because it simplifies the reactor's design. It also prevents the risk of the formation of dead zones close to the baffles in the reactor, in which the polymer particles are trapped, as it were. By preventing this a better polymer quality is obtained because the residence time in the reactor can be better regulated and the spread in residence time will be less.

Another advantage of the reactor without baffles but with such a stirrer is that it can be more flexibly operated because it can at any moment be decided to produce a different ratio of the various polymers without any need to move baffles. It will for example be very easy to change from 50% polymer A in a first zone and 50% polymer B in a second zone to 80% polymer A in a first zone and 20% polymer B in a second zone. Polymers A and B are two polymers that differ from one another in properties or composition.

The type of stirrer in a reactor without physical baffles is not very critical, providing the stirrer ensures radial circulation around the axis and very little to no axial mixing of the powder. A person skilled in this field will be able to easily determine which stirrer is most suitable for carrying out the reaction as desired; see for example “Perry's Chemical Engineer's Handbook”, McGraw Hill Int. Ed., 50^{th} Ed., pp. 21-6. Preferably use is made of a so-called transport-neutral stirrer.

The stirrer's blades may have different designs. Preferably they are of a rectangular design. The blades may be designed with or without openings. The blades' dimensions may be varied within a wide range. It is very well possible to vary the blades' dimensions and/or length/width ratio over the reactor's length. They are however preferably dimensioned so that they have a relatively high length/width ratio. ‘Width’ is here and hereinafter understood to be the projected dimension covered by the blade on the outside wall of the reactor, measured in the direction of the axis. The ‘length’ is understood to be the radial dimension up to the outer tip of the stirrer blade. Preferably the length/width (1/w) ratio is between 6:1 and 1:1. More preferably the length/width (1/w) ratio is between 3:1 and 1:1.

The reactor used in the invention is positioned horizontally. ‘Horizontally’ is here understood to include a position in which the reactor is at a slightly oblique angle, which may amount to at most a factor of 0.2 times the reactor's diameter. If the reactor is at a more oblique angle it will not perform as desired. Preferably the reactor is operated in fully horizontal position.

The reactor is preferably designed so that the first zone in the reactor is provided with means for supplying a diluting gas. This is advantageous because the presence of a diluting gas will make it easier to control the temperature at the beginning of the reactor. This will reduce the risk of the temperature suddenly rising substantially or even threatening to become uncontrollable, for example as a result of a rapid polymerisation reaction of the catalyst. The reliability of the process and also the quality of the polymer produced will benefit from the use of a diluting gas.

The reactor is preferably designed so that the last zone in the reactor is provided with means for supplying a purge gas. ‘Purge gas’ is here understood to be a gas that does not or virtually not dissolve in the polymer and that is inert with respect to the reagents and the polymer. Supplying a purge gas to the last zone in de reactor ensures that part of the monomer, comonomer and any other compounds dissolved in the polymer is already removed from the polymer. The use of a purge gas ensures that the compounds are released at a relatively high pressure, namely the pressure in the reactor, after which they can be returned to the reactor via the section in which the reactor effluent is purified, to take part in the polymerisation reaction once again.

The reactor is operated under sub-fluidisation conditions. This is understood to mean that the rate at which the gas flows through the powder bed is lower than the minimum fluidisation rate. The minimum rate can be calculated using Ergün's equation, as described in Chem. Eng. Progress 48 (1952), 89.

If the reactor is operated so that the rate at which the gas flows through the powder bed is higher than the fluidisation rate, there will no longer be a packed polymer bed in the reactor, in other words a bed consisting of packed polymer particles, but a fluidised bed. If this occurs, total mixing of all the components present will take place in the reactor.

So the rate at which the gas flows through the bed must remain below this limit. Preferably the rate is kept 15-25% below this limit.

1. Process for the preparation of a polymer based on an olefinic monomer and optionally one or more comonomers that are copolymerisable therewith in a horizontal reactor, divided into at least two zones and fitted with a stirring mechanism, which is operated under subfluidisation conditions, the polymer formed being discharged from the reactor separately from other reactor effluent, characterised in that the composition of the overall feed to be supplied to a zone can be varied between two zones at least, the reactor effluent separated from the polymer leaving the reactor as a single stream and at least part of this stream being returned to the reactor as feed via one or more separation steps.

2. Process according to claim 1, characterised in that the composition of the overall feed to be supplied to one zone differs from a previous zone.

3. Process according to claim 1 or claim 2, characterised in that the monomer is ethylene or propylene.

4. Process according to any one of claims 1-3, characterised in that the comonomer is chosen from the group consisting of terminally unsaturated hydrocarbons having 2-12 carbon atoms and conjugated and non-conjugated dienes having 4-20 carbon atoms.

5. Process according to any one of claims 1-4, characterised in that a transition metal catalyst is supplied to the reactor in at least two places.

6. Process according to any one of claims 1-5, characterised in that a prepolymerised catalyst is supplied to the reactor.

7. Device suitable for a process according to any one of claims 1-6, comprising a horizontal reactor, divided into at least two zones and fitted with a stirring mechanism, characterised in that a separating device is also present, which comprises one or more pieces of equipment for separating the reactor effluent into its components and means for returning these components to the reactor.

8. Device according to claim 7, characterised in that the separating device comprises a distillation device.

9. Device according to claim 7 or claim 8, characterised in that the stirring mechanism is a transport-neutral stirrer.

10. Device according to any one of claims 7-9, characterised in that the first zone in the reactor is fitted with means for supplying a diluting gas.

11. Device according to any one of claims 7-10, characterised in that the last zone in the reactor is fitted with means for supplying a purge gas.
